(19) United States
(12) Patent Application Publication
(10) Pub. No.: US 2023/0321604 A1
(43) Pub. Date: Oct. 12, 2023

(54) MEMBRANE-WAFER ASSEMBLY FOR ELECTRODEIONIZATION

(71) Applicants: Yupo J. LIN, Naperville, IL (US); Matthew L. JORDAN, Mount Pleasant, TX (US); Christopher G. ARGES, State College, PA (US)

(72) Inventors: Yupo J. LIN, Naperville, IL (US); Matthew L. JORDAN, Mount Pleasant, TX (US); Christopher G. ARGES, State College, PA (US)

(21) Appl. No.: 17/699,339

(22) Filed: Mar. 21, 2022

(51) Int. Cl. B01D 61/48; C02F 1/469

(52) U.S. Cl. CPC B01D 61/485; C02F 1/4695

(57) ABSTRACT

A membrane-wafer assembly comprises a core resin-wafer (RW) having a first ionexchange surface comprising a thin anionic ionomer layer (AIL) bonded thereto, and a second ion exchange surface comprising a thin cationic ionomer layer (CIL) bonded thereto; wherein the resin-wafer comprises cation exchange resin beads and anion exchange resin beads bound together with a polymeric elastomer. A resin-wafer electrodeionization apparatus comprising a plurality of the membrane-wafer assemblies, and a method of preparing the membrane-wafer assembly also are described.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrodeionization. More particularly, the invention relates to a membrane-wafer assemblies for electrodeionization, and method of preparing the assemblies.

### BACKGROUND OF THE INVENTION

Electrodeionization (EDI), also known as “electrochemical ion-exchange”, is an advanced ion-exchange technology that combines the advantages of ion-exchange and electrodialysis. In electrodeionization processes, ion-exchange resins are sequestered in dilute feed compartments to increase the ionic conductivity, so that even with an ionically dilute feed, a stable operation with higher flux and lower energy consumption than electrodialysis, becomes possible. The electric power also splits the water to H⁺ and OH⁻ ions and the resins are thus regenerated while the ions are removed. A preferred type of electrodeionization is referred to as resin-wafer electrodeionization (RW-EDI). In RW-EDI, the ion-exchange resin beads are bound together with a polymeric elastomer to form a porous wafer, which is sandwiched between ion exchange membranes (i.e., a cation exchange membrane (CEM) and an anion exchange membrane (AEM)) in a framework that holds the resin-wafer and membranes together form an individual RW-EDI cell. Multiple cells are then stacked with product capture chambers between each cell, and sealed between electrodes (a cathode and an anode) with bipolar membranes between the electrodes and the stack to form an RW-EDI stack. See e.g., U.S. Pat. No. 6,495,014 to Datta, Lin, Burke and Tsai, which is incorporated herein by reference in its entirety.

One issue of concern with current RW-EDI cells using current commercial anion-exchange membranes (AEM) is membrane organic fouling, which reduces the separation productivity and increases capital cost of RW-EDI systems due to the larger number of cells required to make up for the lower production of fouled cells. Another issue is the high ion transport resistance of commercial AEMs used in electrochemical separation to capture high carbon-chain acids such as the aromatic acids.

There is an ongoing need for alternative RW-EDI cell configurations that have either less fouling, lower ion transport resistance, or both. The membrane-wafer assemblies and methods described herein address this need.

### SUMMARY OF THE INVENTION

A membrane-wafer assembly (MWA) is described herein, which replaces the three-piece sandwich of ion exchange membranes and a resin-wafer used in conventional RW-EDI cells. A method of fabricating a MWA also is described.

In one aspect, a membrane-wafer assembly comprises a core resin-wafer (RW) having a first ion-exchange surface comprising a thin anionic ionomer layer (AIL) bonded thereto, and a second ion exchange surface comprising a thin cationic ionomer layer (CIL) bonded thereto; wherein the resin-wafer comprises cation exchange resin beads and anion exchange resin beads bound together with a polymeric binder. As used herein, the term “thin” with respect to an AIL or CIL refers to a layer having a thickness in the range of about 25 µm to about 200 µm, preferably about 50 µm to about 120 µm. As used herein, the term “anionic ionomer” refers to ionomers with anion exchange functional groups (e.g., amines and/or quaternary ammonium groups); and the term “cationic ionomer” refers ionomers with cation exchange functional groups (e.g., sulfonic acid, phosphonic acid, and/or carboxylic acid groups).

Unlike current RW-EDI cells, which use three separate components (an anion exchange membrane, a resin-wafer, and a cation exchange membrane) that are physically held in contact by a framework of plates and gaskets, the MWA described herein is a single unit which is thinner than the conventional cell for a given thickness of resin-wafer. This provides for a simpler stack complexity (i.e., fewer parts per cell), and provides a more cohesive conductive network for exchange of ions across the ion exchange surfaces of the resin-wafer. In conventional RW-EDI cells, each component (CEM, AEM and RW) has its own resistance toward ion transport (R), and the interfacial gaps between the AEM and RW and between the RW and CEM also have their own resistance. The total resistance, Rₜₒₜₐₗ, for a convention cell is equal to R_{CEM}+ R_{CEM-RW} Interface + R_{RW} + R_{AEM-RW} Interface + R_{AEM}. In contrast, the MWA has a single resistance, R_{MWA}, that is lower than the Rₜₒₜₐₗ for the conventional RW-EDI cell. In addition, the use of a single membrane-wafer assembly in place of the current, three-component CEM/RW/AEM combination, will also significantly simplify the assembly or RW-EDI stacks, thus significantly reducing the service time and cost of EDI stack maintenance.

In another aspect, a method of fabricating a MWA comprises forming a stack comprising a resin-wafer between a thin sheet of anionic ionomer and a thin sheet of cationic ionomer in a mold, and then hot-pressing the stack within the mold at a pressure in the range of about 0.5 to about 2 metric tons of force, at a temperature of about 120° C. to about 160° C., for example about 150° C., for a time sufficient to fuse the anionic ionomer and the cationic ionomer to the resin-wafer (e.g., about 5 minutes (min) to about 40 min, for example, about 15 min) thereby forming the MWA; wherein the resin-wafer comprises cation exchange resin beads and anion exchange resin beads bound together with a polymeric binder.

In some embodiments, an antifouling functional group or agent (e.g., zwitterions, polydopamine, etc.) can be included in the anionic ionomer to inhibit organic fouling, which is commonly observed with the AEM of conventional RW-EDI cells. For example, the AIL can be prepared in situ on one surface of the resin-wafer by polymerizing suitable anion exchange ionomeric monomers on the surface. Such an in-situ preparation allows for inclusion of an anti-organic-fouling functional monomer or agent in the AIL to prevent or minimize organic fouling on the AIL.

In another aspect, an MWA-EDI apparatus includes one or more MWA as described herein in place of the three-component combination of AEM, RW and CEM used in conventional RW-EDI.

The following non-limiting embodiments are provided to illustrate certain features and aspects of the methods and assemblies described herein.

Embodiment 1 is a membrane-wafer assembly comprising a core porous resin-wafer (RW) having a first ion-exchange surface comprising a thin anionic ionomer layer (AIL) bonded thereto, and a second ion exchange surface comprising a thin cationic ionomer layer (CIL) bonded thereto; wherein the resin-wafer comprises cation exchange resin beads and anion exchange resin beads bound together with a polymeric binder; and the AIL and CIL each independently have a thickness in the range of about 25 µm to about 200 µm.

Embodiment 2 is the membrane-wafer assembly of embodiment 1, wherein the AIL and CIL each independently have a thickness in the range of about 50 µm to about 120 µm.

Embodiment 3 is the membrane-wafer assembly of embodiment 1 or embodiment 2, wherein the AIL comprises a polymer backbone such as polysulfone which bears primary, secondary, tertiary, or quaternary derivative of an amino, phosphine or sulfone groups.

Embodiment 4 is the membrane-wafer assembly of any one of embodiments 1 to 3, wherein the AIL comprises quaternary benzyl n-methyl pyridinium chloride poly(arylene ether sulfone).

Embodiment 5 is the membrane-wafer assembly of any one of embodiments 1 to 4, wherein the CIL comprises a polymer backbone such as polysulfone or polyether ether ketone which bears sulfonic acid, phosphonic acid, and/or carboxylic acid groups.

Embodiment 6 is the membrane-wafer assembly of any one of embodiments 1 to 5, wherein the CIL comprises sulfonated poly(arylene ether sulfone).

Embodiment 7 is the membrane-wafer assembly of any one of embodiments 1 to 6, wherein the anionic ion exchange resin beads are selected from the group consisting of polymer beads comprising sulfonic acid functional groups on the surface thereof; and polymer beads comprising carboxylic acids functional groups on the surface thereof, and the cation ion exchange resin beads are selected from the group consisting of polymer beads comprising quaternary amino groups on the surface thereof, and polymer beads comprising primary, secondary, or tertiary amino groups on the surface thereof.

Embodiment 8 is the membrane-wafer assembly of any one of embodiments 1 to 8, wherein polymeric binder is selected from the group consisting of an anionic ionomer, a cationic ionomer, and a non-ionic elastomer.

Embodiment 9 is a method for fabricating a membrane-wafer assembly comprising the steps of:
(a) providing a layered stack comprising a cationic ionomer sheet, a porous resin-wafer comprising a first ion-exchange surface and a second ion-exchange surface, and an anionic ionomer sheet; wherein the cationic ionomer sheet contacts and covers the first ion-exchange surface of the resin-wafer, and the anionic ionomer sheet contacts and covers the second ion-exchange surface of the resin-wafer;
(b) hot-pressing the stack from step (a) in a mold at a pressure, a temperature, and for a period of time sufficient to fuse the cationic ionomer sheet and the anionic ionomer sheet to the resin-wafer, thereby forming a cationic ionomer layer (CIL) on the first ion-exchange surface of the resin-wafer, and an anionic ionomer layer (AIL) on the second ion-exchange surface of the resin-wafer;
wherein the resin-wafer comprises cation exchange resin beads and anion exchange resin beads bound together with a polymeric binder; and the AIL and CIL each independently have a thickness in the range of about 25 µm to about 200 µm.

Embodiment 10 is the method of embodiment 9, wherein the anionic ionomer sheet and the cationic ionomer sheet each independently have a thickness in the range of about 50 µm to about 120 µm.

Embodiment 11 is the method of embodiment 9 or embodiment 10, wherein the anionic ionomer sheet comprises a polymer backbone such as polysulfone which bears primary, secondary, tertiary, or quaternary amino, phosphine, or sulfone groups; and cationic ionomer sheet comprises a polymer backbone such as polysulfone or polyether ether ketone which bears sulfonic acid, phosphonic acid, and/or carboxylic acid groups.

Embodiment 12 is the method of any one of embodiments 9 to 11, wherein the anionic ionomer sheet comprises quaternary benzyl n-methyl pyridinium chloride poly(arylene ether sulfone); and the cationic ionomer sheet comprises sulfonated poly(arylene ether sulfone).

Embodiment 13 is the method of any one of embodiments 9 to 12, wherein the mold is lined with poly(tetrafluoroethylene) sheets disposed between mold and the stack.

Embodiment 14 method of any one of embodiments 9 to 13, wherein the temperature is about 120° C. to about 160° C.

Embodiment 15 is the method of any one of embodiments 9 to 14, wherein the pressure is in the range of about 0.5 to about 2 metric tons of force.

Embodiment 16 is the method of any one of embodiments 9 to 15, wherein the hot-pressing is continued for about 5 minutes to about 40 minutes.

Embodiment 17 is the method of any one of embodiments 9 to 16, wherein anionic ion exchange resin beads are selected from the group consisting of polymer beads comprising sulfonic acid functional groups on the surface thereof; and a polymer beads comprising carboxylic acids functional groups on the surface thereof; and the cation ion exchange resin beads are selected from the group consisting of polymer beads comprising quaternary amino groups on the surface thereof, and polymer beads comprising primary, secondary, or tertiary amino groups on the surface thereof.

Embodiment 18 is the method of any one of embodiments 9 to 17, wherein polymeric binder is selected from the group consisting of an anionic ionomer, a cationic ionomer, and a non-ionic elastomer.

Embodiment 19 is a membrane-wafer assembly electrodeionization apparatus (MWA-EDI comprising a cathode, an anode, and a stack of membrane-wafer assemblies between the anode and the cathode, wherein each membrane wafer assembly (MWA) is a MWA of any one of embodiments 1 to 8; each MWA is compressed between two gaskets to form a diluate chamber; a concentrate chamber is positioned between each diluate chamber; the diluate chambers are oriented with the AIL thereof facing the anode, and the CIL of thereof facing the cathode; and the concentrate chambers and diluate chambers configured and assembled for fluid flow therebetween.

Embodiment 20 is the RW-EDI apparatus of embodiment 19, wherein bipolar membranes are positioned between the cathode and the stack and between the anode and the stack.

In use, the MWA replaces the three-piece combination of AEM, RW, and CEM used in conventional RW-EDI systems. The MWA is placed withing a gasket that has passageways for fluid flow between the MW As in an RW-EDI stack. The AEMs and CEMs of the conventional systems also act as gaskets for fluid containment, requiring ion exchange membranes (AEM and CEM) that are larger in area than the resin-wafer. AEMs and CEMs are very expensive gasket materials. In contrast, the MWA is used with a rubber gasket to provide fluid containment, which allows for the use of a smaller total membrane area per wafer, since the membrane layers and wafer have the same area. This greatly reduces the cost of a RW-EDI system.

The methods and apparatus described herein consist of certain novel features and a combination of parts hereinafter fully described, illustrated in the accompanying drawings, and particularly pointed out in the appended claims, it being understood that various changes in the details may be made without departing from the spirit, or sacrificing any of the advantages, of the present invention.

### BRIEF DESCRIPTION OF THE DRAWINGS

FIG. 1 provides a schematic illustration of an MWA as described herein.

FIG. 2 provides a schematic illustration of a portion of a conventional RW-EDI apparatus of the prior art.

FIG. 3 provides a schematic illustration of a conventional RW-EDI apparatus of the prior art.

FIG. 4 provides a schematic illustration of a MWA-EDI apparatus having a single diluate chamber as described herein.

FIG. 5 provides a schematic illustration of a cross-section of an MWA housed between two gaskets.

FIG. 6 provides a schematic illustration of a MWA-EDI apparatus having a multiple diluate chambers.

FIG. 7 provides comparison graphs of p-coumarate removal ratio, capture ratio, and energy consumption for RW-EDI compared to an MWA-EDI.

FIG. 8 provides comparison graphs of non-aromatic carboxylic acid separation performance between RW-EDI and MWA-EDI systems.

FIG. 9 shows comparison graphs of aromatic acid separation and recovery performance using RW-EDI and WMA-EDI from p-coumarate solution with same operation conditions.

### DETAILED DESCRIPTION

A membrane-wafer assembly as described herein comprises a resin-wafer (RW) having a thin anionic ionomer layer (AIL) bonded to one surface and a thin cationic ionomer layer (CIL) bonded to a second opposed surface thereof. As described herein are a method of preparing the membrane-wafer assembly, and an EDI apparatus comprising the membrane wafer assemblies.

### Membrane-Wafer Assemblies

In one aspect, a membrane-wafer assembly comprises three primary components: a resin-wafer (RW) having a thin anionic ionomer layer (AIL) bonded to one surface and a thin cationic ionomer layer (CIL) bonded to a second opposed surface thereof. The resin-wafer typically comprises three components; cation exchange beads, anion exchange beads and a binder. A porosigen, such as a soluble salt (e.g., NaCl), is typically included during manufacture of the resin-wafer, however the porosigen is then removed, e.g., by pumping water through the wafer, prior to use.

### Resin-Wafer

The resin-wafer comprises cation exchange resin beads and anion exchange resin beads bound together with a polymeric binder. The resin-wafer can be prepared in any desired shape, size or thickness. Typically, the resin wafer is rectangular in shape and has a thickness in the range of about 2 cm to about 4 cm. The resin-wafer is porous to allow fluid to flow through the wafer. Typically, the resin wafer has a porosity of about 10% to about 35%.

The cation exchange resin beads and be composed of a strong cation exchange resin, a weak cation exchange resin, or both. Strong cation exchange resin beads are polymeric beads having strongly acidic groups on the surface of the beads, such as sulfonic acid or phosphonic acid groups, Weak cation exchange resin beads are polymeric beads having weakly acidic groups on the surface of the beads, such as carboxylic acids and phenolic hydroxyl groups. The acidic groups on the beads are neutralized with a base, such as ammonia, to form salts in which the anions are fixed in place on the beads, and the cations are changeable when in an aqueous environment. Strong cation exchange resin beads typically are polystyrene beads having sulfonic acid functional groups on the surface thereof. Weak cation exchange resin beads typically are polyacrylate beads with carboxylic acid functional groups on the surface thereof.

The anion exchange resin beads and be composed of a strong anion exchange resin, a weak anion exchange resin, or both. Strong anion exchange resin beads are polymeric beads having strongly basic groups on the surface of the beads, such as quaternary ammonium or quaternary phosphonium groups. Weak cation exchange resin beads are polymeric beads having weakly basic groups on the surface of the beads, such as primary, secondary or tertiary amines, or nitrogen heteroaryl groups such as pyridine or imidazole groups. The basic groups on the beads are neutralized with water or an acid to form salts in which the cations are fixed in place on the beads, and the anions are changeable when in an aqueous environment. Strong anion exchange resin beads typically are polymeric beads having quaternary ammonium groups on the surface thereof (e.g., methylene trialkylammonium groups or quaternized polyethyleneimine groups). Weak anion exchange resin beads typically are polymeric beads with tertiary amino groups or polyethylene imine groups on the surface thereof.

Cation and anion exchange resin beads are well known in the art and are commercially available from a number of sources and are sold under a number of tradenames including AMBERLITE, AMBERLIST, AMBERJET, DOWEX, DUOLITE, PUROLITE, and RESINEX, to name a few. The beads used to make the resin-wafer typically have a size in the range of about 50 µm to about 1200 µm. In some embodiments, the beads used to make the resin-wafer typically have a size in the range of about 300 µm to about 1200 µm. In other embodiments, the beads used to make the resin-wafer typically have a size in the range of about 300 um to about 700 um.

The polymeric binder can be an anionic ionomer (also referred to as an anion exchange ionomer), a cationic ionomer (also referred to as a cation exchange ionomer), a polymer without ionomer functional groups (e.g., low-density polyethylene or high-density polyethylene elastomers), or any combination thereof. Examples of anionic ionomer binders include a multi-block or random quaternary ammonium poly (arylene ether sulfone) copolymer, a multiblock or random quaternary ammonium poly (ether sulfone), and the like. Typically, the resin-wafer comprises a ratio of resin to binder of about 20:1 to about 3:1 (see e.g., U.S. Pat. No. 6,495,014 to Datta et al.). In some embodiments, the polymeric binder typically is included in the resin wafer in a weight ratio of resin-to-binder of about 10:1 to about 1:1. In other embodiments, the polymeric binder typically is included in the resin wafer in a weight ratio of resin-to-binder of about 2:1 to about 1:1. Preferred binders are cationic or anionic ionomers. Such ionomers and polymers are well known in the art.

A preferred polymeric binder is a commercially available quaternary ammonium functionalized poly(arylene ether sulfone) having repeating units of the formula:

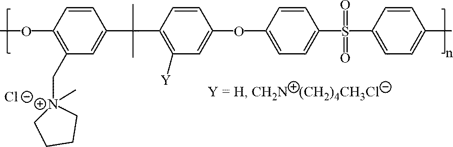

### Cationic Ionomer Layer (CIL)

The cationic ionomer layer can be any polymer backbone such as polysulfone or polyether ether ketone which contains a sulfonic acid, phosphonic acid, and/or carboxylic acid group.

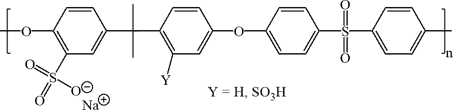

The CIL has a thickness in the range of about 25 µm to about 200 µm. In some embodiments the CIL has a thickness in the range of about 50 µm to about 160 µm. In other embodiments, the CIL has a thickness in the range of about 100 µm to about 120 µm.

### Anionic Ionomer Layer (AIL)

The anionic ionomer layer can be composed of any polymer backbone such as polysulfone which contains a primary, secondary, tertiary or quaternary derivative of an amino, phosphine or sulfone group.

The AIL has a thickness in the range of about 25 µm to about 200 µm. In some embodiments, the AIL has a thickness in the range of about 60 µm to about 160 µm. In other embodiments, the AIL has a thickness in the range of about 100 µm to about 120 µm.

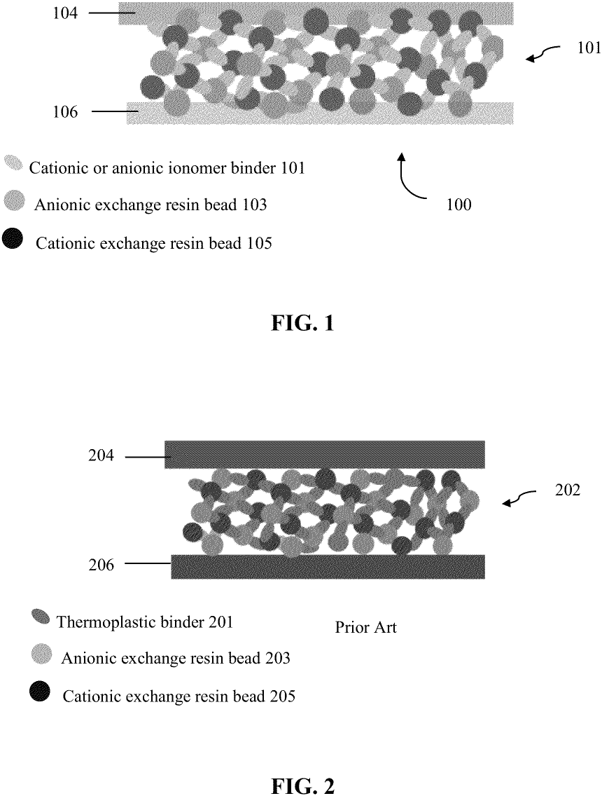

FIG. 1 schematically illustrates a MWA as described herein. In FIG. 1, MWA 100 comprises resin-wafer 101 bonded to anionic ionomer layer 104 on one side thereof and to cationic ionomer layer 106 on an opposed side thereof. Resin-wafer 101 is composed of anionic exchange resin beads 103 and cation exchange resin beads 105 bound together by a cationic or anionic ionomer binder 101.

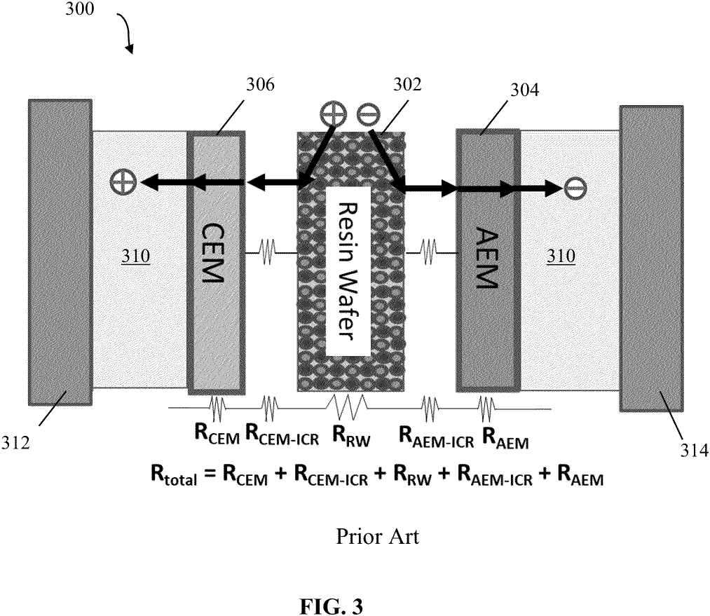

In comparison, FIG. 2 illustrates a conventional combination of separate resin-wafer, AEM and CEM used in conventional RW-EDI. In FIG. 2 illustrates a combination of three separate components making up a portion of an EDI cell. The components include resin-wafer 201 flanked on either side thereof by an anionic exchange membrane 204 and a cation exchange membrane 206. Resin-wafer 202 is composed of anionic exchange resin beads 203 and cation exchange resin beads 205 bound together by a thermoplastic binder 201.

The MWA of FIG. 1 is used in place of the combination shown in FIG. 2 to produce a modified RW-EDI system, which can be referred to as MWA-EDI.

### Methods for Preparing the Membrane Wafer Assembly

A method of preparing the membrane-wafers assembly comprises the steps of:
(a) providing a layered stack comprising a cationic ionomer sheet, a porous resin-wafer comprising a first surface and a second surface, and an anionic ionomer sheet; wherein the cationic ionomer sheet contacts and covers the first surface of the resin-wafer, and the anionic ionomer sheet contacts and covers the second surface of the resin-wafer;
(b) hot-pressing the stack from step (a) in a mold at a pressure, a temperature, and for a period of time sufficient to fuse the cationic ionomer sheet and the anionic ionomer sheet to the resin-wafer, thereby forming a cationic ionomer layer (CIL) on the first surface of the resin-wafer, and an anionic ionomer layer (AIL) on the second surface of the resin-wafer;
wherein the resin-wafer comprises cation exchange resin beads and anion exchange resin beads bound together with a polymeric binder; and the AIL and CIL each independently have a thickness in the range of about 100 µm to about 120 µm.

In the method, the cationic ionomer sheet is composed of the same ionomer as the CIL described above with respect to the components of the MWA. The cationic ionomer sheet typically has a thickness in the range of about 40 µm to about 300 µm before hot pressing. In some embodiments, the cationic ionomer sheet typically has a thickness in the range of about 80 µm to about 200 µm before hot pressing. In other embodiments, the cationic ionomer sheet typically has a thickness in the range of about 120 µm to about 180 µm before hot pressing.

In the method, the anionic ionomer sheet is composed of the same ionomer as the CIL described above with respect to the components of the MWA. The anionic ionomer sheet typically has a thickness in the range of about 40 µm to about 300 µm before hot pressing. In some embodiments, the anionic ionomer sheet typically has a thickness in the range of about 80 µm to about 200 µm before hot pressing. In other embodiments, the anionic ionomer sheet typically has a thickness in the range of about 120 µm to about 180 µm before hot pressing.

The resin-wafer used in the method is the same as the resin-wafer described above for with respect to the components of the membrane-wafer assembly. The cationic and anionic ionomer sheets are cut to the same shape as the resin-wafer, and substantially cover the large area surfaces of the resin-wafer.

Typically, hot-pressing is performed at a pressure in the range of about 0.5 to about 2 metric tons of force. In some embodiments, hot-pressing is performed at a pressure in the range of about 2 metric tons of force.

Typically, the hot-pressing temperature is in the range of about 100° C. to about 200° C. In some embodiments, the hot-pressing temperature is in the range of about 120° C. to about 160° C. In other embodiments, the hot-pressing temperature is in the range of about 140° C. to about 160° C.

Hot-pressing is continued for a period of time sufficient to bond the ionomer sheets to the resin wafer to form the AIL and CIL. Typically, the hot-pressing is continued for about 5 to about 180 min. In some embodiments, the hot-pressing is continued for about 5 to about 60 min. In other embodiments, the hot-pressing is continued for about 5 to about 40 min.

Preferably, the mold for the hot-pressing is composed of or lined with a materials that resists sticking to the ionomer sheets. In some preferred embodiments, poly(tetrafluoroethylene) sheets are place between the ionomer sheets and the mold to prevent sticking.

### EDI Apparatus Comprising a Membrane-Wafer Assembly

FIG. 3 schematically illustrates conventional RW-EDI apparatus 300, with a single exchange cell. Apparatus 300 comprises a cathode 312 and an anode 314 flanking an RW-EDI cell. The RW-EDI cell comprises resin-wafer 302 between CEM 306 and AEM 304, which together form a diluate chamber, with a first concentrate chamber 310 between the diluate chamber and cathode 312 and a second concentrate chamber 310 between the diluate chamber and anode 314. In some embodiments, a bipolar membrane is positioned between the cathode and the nearest concentrate chamber, and another bipolar membrane is positioned between the anode and the nearest concentrate chamber, as is well known in the art. As illustrated in FIG. 3, ion-transport involves flow of positively charged cations toward the cathode and flow of negatively charged anions toward the anode when a voltage is applied across the anode and cathode. The resistance to ion transport (Rₜₒₜₐₗ) in apparatus 300 is the sum of the resistances of the CEM (R_{CEM}), AEM (R_{AEM}), and RW (R_{RW}) components, as well as the resistance found at the interfaces between the CEM and RW (R_{CEM-ICR}) and between the AEM and the RW (R_{AEM-ICR}). In the MWA-EDI apparatus described herein, the interfacial resistances are reduced to substantially zero, thus lowering the ion-transport resistance of each cell by a significant amount. This increases the energy efficiency and through put of MWA-EDI relative to conventional RW-EDI. A typical RW-EDI apparatus has multiple diluate chambers flanked by concentrate chambers is a stack.

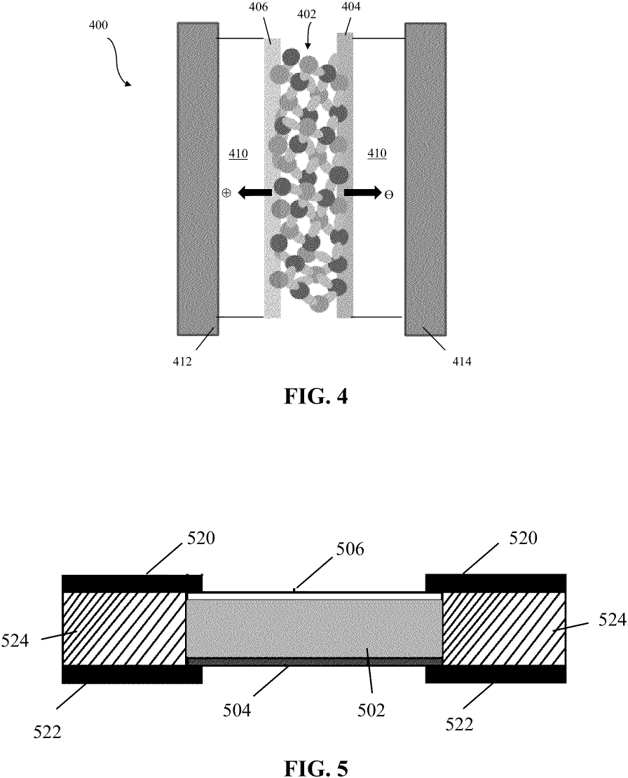

FIG. 4 schematically illustrates an MWA-EDI apparatus 400 having a single diluate chamber, as described herein. Apparatus 400 comprises a cathode 412 and an anode 414 flanking an MWA comprising a resin-wafer 402 bonded to a CIL 406 and an AIL 404. The MWA is the diluate chamber in the apparatus, and a first concentrate chamber 410 is disposed between the MWA and cathode 412 and a second concentrate chamber 410 is disposed between the MWA and anode 414. In some embodiments, a bipolar membrane is positioned between the cathode and the nearest concentrate chamber, and another bipolar membrane is positioned between the anode and the nearest concentrate chamber, as in an RW-EDI apparatus.

FIG. 5 illustrates a cross-section of a MWA housed within a gasket. In FIG. 5, an MWA comprising resin-wafer 502 bonded to CIL 506 and AIL 504. The MWA is sandwiched between a first gasket 520 and a second gasket 522, with reinforcing backing 524 between gaskets 520/522, and around the MWA. Gaskets 520 and 522 cover only a relatively small portion of the MWA to allow for ion transport out of the MWA during use.

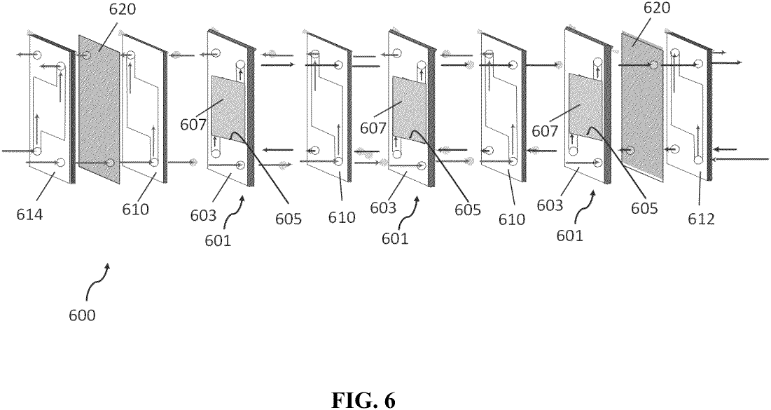

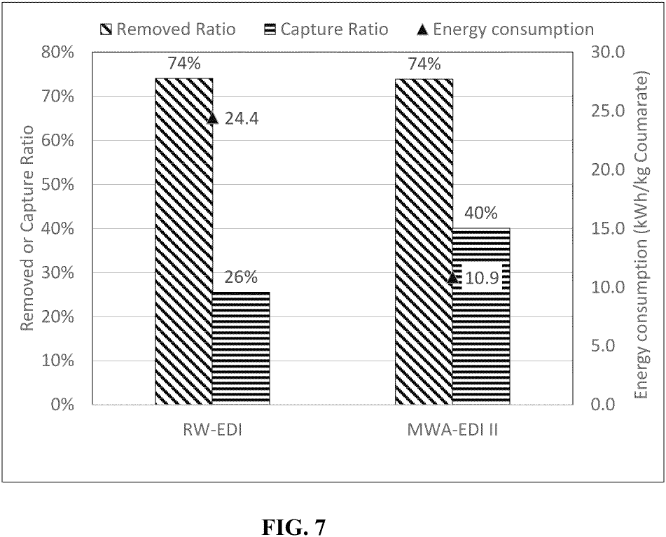

FIG. 6 schematically illustrates a partially exploded view of a MWA-EDI apparatus comprising multiple diluate chambers. MWA-EDI Apparatus 600 comprises an anode 614 at one end thereof and a cathode 612 at the other end thereof, with three diluate chambers 601 between anode 614 and cathode 612. Each diluate chamber comprises a membrane wafer assembly 607 within a gasket assembly 603 that defines apertures 605. A concentrate chamber 610 is positioned adjacent each diluate chamber 601 on the anode side thereof. A first bipolar membrane 620 is positioned between anode 614 and the adjacent concentrate chamber 610, and a second bipolar membrane 620 is positioned between cathode 612 and adjacent diluate chamber 601. Arrows indicate the fluid flow pathways into, out of, and within apparatus 600. In use, the MWA-EDI apparatus operates similarly to a conventional RW-EDI, but with higher efficiency.

### EXAMPLES

### General Procedure for MWA Fabrication

The membrane wafer assembly fabrication comprises of blending a 5 to 20 wt % solution of quaternary benzyl n-methyl imidazolium poly(arylene ether sulfone) binder (QIPSf) in N-methylpyrrolidone (NMP) solvent with a fixed capacity ratio of cation to anion exchange resin beads, for example, an ion exchange capacity ratio of about 1:1.15, and sodium chloride porosigen in a mass ratio such as 3.0:2.5:2 (beads:ionomer binder:salt). The anion to cation exchange resin ratio is an important parameter in ion-exchange processes to maintain isoneutrality and compensate for differences in ionic mobilities. The ionomer binder is added into the resin beads mixture followed by the sodium chloride. The resulting slurry is well mixed and then cast into a stainless-steel mold. The mold is hot pressed at a temperature of about 135° C. for about 2 to 3 hours at a pressure of about 2 to 3 metric tons of force to liquify the binder. The resin wafer then solidifies upon cooling in ambient air to room temperature.

Separate from the resin wafer fabrication process, thin films of ionomers are solution-cast on non-stick, hard plates. The ionomer solutions consist of a 7 wt % QIPSf solution in NMP for the anion exchange thin films and a 7 wt % sulfonated poly(arylene ether sulfone) (SPSf) solution for the cation exchange thin films. These thin films typically have a thickness of about 60 to 80 µm prior to lamination. The resin wafer is then sandwiched with the thin films and TEFLON liners inside a stainless-steel mold in the following order: a non-stick TEFLON liner, an anion exchange thin film, the resin wafer, a cation exchange thin film, and another TEFLON liner. The mold is hot pressed at a temperature of about 120° C. to 160° C. for about 15 to 20 minutes at a pressure of about 0.5 to 2 metric tons of force, in order to thermally laminate the ionomer films to the resin wafer surface. After cooling to room temperature in ambient air, the resulting membrane wafer assembly is immersed in deionized water for about 20 minutes to remove sodium chlorides, and this wash is repeated three times.

### Specific Preparation of an MWA for Testing

A resin-wafer was fabricated by blending about 10 mL of a 14 wt % NMP solution of QIPSf binder with about 12 grams of a mixture of 1:1.15 ion exchange capacity ratio of cation to anion exchange resin beads. NaCl (about 5 grams) was then added. The resulting slurry was well mixed and then cast into a stainless-steel mold. The mold was hot pressed at a temperature of about 135° C. for about 2 hours at a pressure of about 2 metric tons of force to liquify the binder. The resin wafer then solidified upon cooling in ambient air to room temperature.

Thin films of each of the ionomers (QIPSf and SPSf) were separately solution-cast on non-stick, hard plates as described in the general procedure. These thin films had a thickness of about 60 to 80 µm prior to lamination. The resin wafer was then sandwiched inside a stainless-steel mold with the thin films and TEFLON liners as described in the general procedure. The mold was hot pressed at a temperature of about 150° C. for about 15 minutes at a pressure of about 2 metric tons of force. After cooling to room temperature in ambient air, the resulting MWA was immersed in deionized water for about 20 minutes to remove sodium chlorides, and this wash was repeated three times. This MWA was then tested as described below.

### Performance Evaluations of MWA

An experiment was conducted to show the impact of the use of MWA material in an MWA-EDI device compared to the current practice of RW-EDI on the separation performance of recovering organic acids from aqueous stream. The MWA was composed of a 10.4 % quaternary benzyl imidazolium poly(arylene ether sulfone) ionomer binder, and 89.6 % ion-exchange resin (with approximately an 0.7:1 ratio of PUROLITE PFA400:PFC100E resins by ion-exchange capacity). The cation thin coating layer on the MWA consisted of sulfonated poly(arylene ether sulfone) and anion thin coating layer consisted of quaternary benzyl imidazolium poly(arylene ether sulfone), which is the same ionomer as the core resin wafer material. The MWA reduced the transport resistance while increasing the organic salt uptake rate into the acid capture stream when incorporated into an EDI stack. A single cell pair of MWA-EDI stack, like the configuration shown in FIG. 6 except it only had one cell-pair, was evaluated to assess the performance of the MWA-EDI apparatus for capturing aromatic salt (p-coumarate) from an aqueous stream. FIG. 7 shows the comparison of p-coumarate capture ratio and energy consumption. Operated in a batch, at 74% p-coumarate removal ratio from the stream using RW-EDI and MWA-EDI, the capture ratio of p-coumarate enhanced more than 50% by MW A-EDI. Due to the thin layer (~20 um) and homogenous phase of anionic-conductive ionomer coating on an ionomer bound resin wafer, the energy consumption of MWA-EDI was reduced 55%. The resin wafer provides the mechanic strength necessary to sustain the flow pressure.

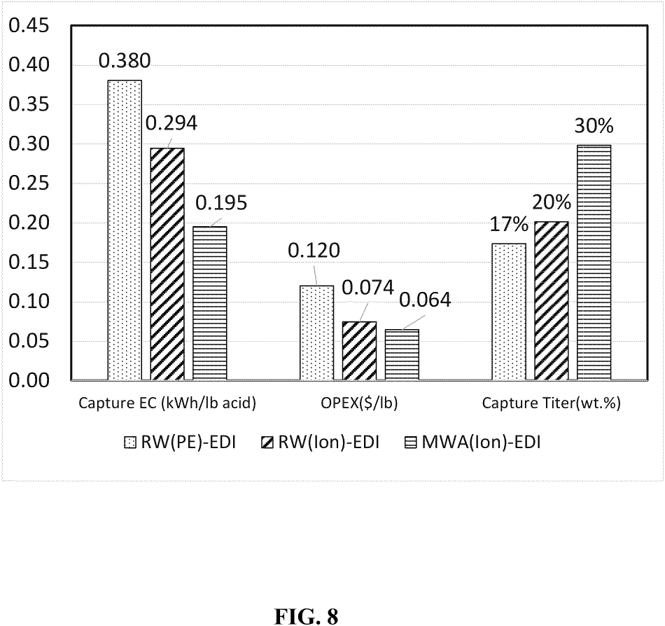

In another example, a multiple cell-pair EDI stack as configured like FIG. 6, and a side-by-side comparison was made of the separation performance using this new MW A-EDI stack (with the same composition described above) and resin wafer electrodeionization (RW-EDI). The RW-EDI stacks were filled with two different types of wafer material: one with a non-ionic-conductive binder of polyethylene (PE) and another with quaternary benzyl imidazolium poly(arylene ether sulfone) ionomer binder. The PE resin wafer was composed of a 2:1 ratio of ion-exchange resin to polyethylene binder while the ionomer binder was composed of 89.6 % ion-exchange resin and 10.4 % ionomer binder. The ion-exchange resins were formulated to have an approximately 0.7:1 ratio of PUROLITE PFA400:PFC100E resins by ion-exchange capacity. Commercial NEOSEPTA AMX and CMX membranes were used in the RW-EDI builds. The benchmark separations were conducted in different organic acids solutions, i.e., sodium lactate and p-coumarate solution, respectively. In summary, three different types of EDI stack were evaluated in the same operation conditions and process streams. They are labeled as RW(PE)-EDI, RW(Ionomer)-EDI and MWA(Ionomer)-EDI. FIG. 8 shows the separation performance of these EDI stacks to capture lactate from a Sodium-Lactate solution. The results show distinct enhancement of lactate separation, capture, and concentrate by MWA-EDI. The most significant impact of the performance improvement is a close to 70% energy reduction that led to 68% reduction of operation cost (OPEX). The captured titer of lactate was also doubled.

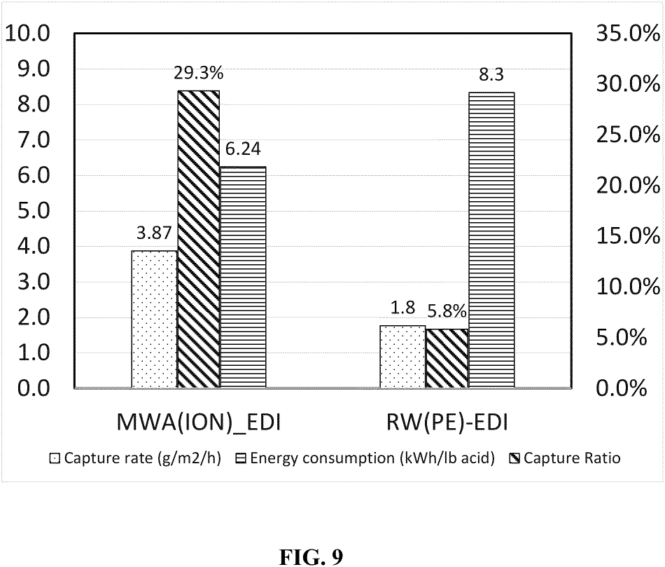

Similar evaluations of these stacks for recovering an aromatic acid, i.e., p-coumarate, were conducted. FIG. 9 shows the same pattern of reduction of energy consumption by 25%. However, the most significant enhancement was a 5-fold increase of the aromatic acid capture ratio. It was contributed by the high ion-adsorption capacity of ion-conductive ionomer binder in the MWA compared to the no adsorption capacity of the polyethylene binder in RW. Because of the thin ion-conductive membrane coating of the MWA compared to commercial thick ion-exchange membrane, the capture rate was increased by 2.5-fold.

In summary, the MWA-EDI has been demonstrated to achieve superior separation performance compared to RW-EDI technology.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A membrane-wafer assembly comprising a core porous resin-wafer (RW) having a first ion-exchange surface comprising a thin anionic ionomer layer (AIL) bonded thereto, and a second ion exchange surface comprising a thin cationic ionomer layer (CIL) bonded thereto; wherein the resin-wafer comprises cation exchange resin beads and anion exchange resin beads bound together with a polymeric binder; and the AIL and CIL each independently have a thickness in the range of about 25 µm to about 200 µm.

2. The membrane-wafer assembly of claim 1, wherein the AIL and CIL each independently have a thickness in the range of 50 µm to about 120 µm.

3. The membrane-wafer assembly of claim 1, wherein the AIL is a polymer bearing primary, secondary, tertiary, or quaternary amino, phosphine, or sulfone groups.

4. The membrane-wafer assembly of claim 1, wherein the AIL comprises a quaternary benzyl n-methyl pyridinium chloride poly(arylene ether sulfone).

5. The membrane-wafer assembly of claim 1, wherein the CIL is polymer bearing sulfonic acid, phosphonic acid, and/or carboxylic acid group.

6. The membrane-wafer assembly of claim 1, wherein the CIL comprises a sulfonated poly(arylene ether sulfone).

7. The membrane-wafer assembly of claim 1, wherein the anionic ion exchange resin beads are selected from the group consisting of polymer beads comprising quaternary amino groups on the surface thereof, and polymer beads comprising primary, secondary, or tertiary amino groups on the surface thereof.

8. The membrane-wafer assembly of claim 1, wherein polymeric binder is selected from the group consisting of an anionic ionomer, a cationic ionomer, and a non-ionic elastomer.

9. A method for fabricating a membrane-wafer assembly comprising the steps of:
(a) providing a layered stack comprising a cationic ionomer sheet, a porous resin-wafer comprising a first surface and a second surface, and an anionic ionomer sheet; wherein the cationic ionomer sheet contacts and covers the first surface of the resin-wafer, and the anionic ionomer sheet contacts and covers the second surface of the resin-wafer;
(b) hot-pressing the stack from step (a) in a mold at a pressure, a temperature, and for a period of time sufficient to fuse the cationic ionomer sheet and the anionic ionomer sheet to the resin-wafer, thereby forming a cationic ionomer layer (CIL) on the first surface of the resin-wafer, and an anionic ionomer layer (AIL) on the second surface of the resin-wafer;
wherein the resin-wafer comprises cation exchange resin beads and anion exchange resin beads bound together with a polymeric binder; and the AIL and CIL each independently have a thickness in the range of 25 µm to about 200 µm.

10. The method of claim 9, wherein the anionic ionomer sheet and the cationic ionomer sheet each independently have a thickness in the range of 50 µm to about 120 µm.

11. The method of claim 9, wherein the anionic ionomer sheet comprises a polymer bearing primary, secondary, tertiary, or quaternary amino, phosphine, or sulfone groups; and cationic ionomer sheet comprises a polymer bearing sulfonic acid, phosphonic acid, and/or carboxylic acid groups.

12. The method of claim 9, wherein the anionic ionomer sheet comprises a quaternary benzyl n-methyl pyridinium chloride poly(arylene ether sulfone); and the cationic ionomer sheet comprises a sulfonated poly(arylene ether sulfone).

13. The method of claim 9, wherein the mold is lined with poly(tetrafluoroethylene) sheets disposed between mold and the stack.

14. The method of claim 9, wherein the temperature is about 120° C. to about 160° C.

15. The method of claim 9, wherein the pressure is about 0.5 to about 2 metric tons of force.

16. The method of claim 9, wherein the hot-pressing is continued for about 5 minutes to about 40 minutes.

17. The method of claim 9, wherein the anionic ion exchange resin beads are selected from the group consisting of polymer beads comprising quaternary amino groups on the surface thereof, and polymer beads comprising primary, secondary, or tertiary amino groups on the surface thereof; and the cation ion exchange resin beads are selected from the group consisting of polymer beads comprising sulfonic acid functional groups on the surface thereof, and polymer beads comprising carboxylic acids functional groups on the surface thereof.

18. The method of claim 9, wherein polymeric binder is selected from the group consisting of an anionic ionomer, a cationic ionomer, and a non-ionic elastomer.

19. A membrane-wafer assembly electrodeionization (MWA-EDI) apparatus comprising a cathode, an anode, and a stack of membrane-wafer assemblies between the anode and the cathode; wherein each membrane-wafer assembly (MWA) in the stack comprises a thin anionic ionomer layer (AIL) bonded thereto, and a second ion exchange surface comprising a thin cationic ionomer layer (CIL) bonded thereto; wherein the resin-wafer comprises cation exchange resin beads and anion exchange resin beads bound together with a polymeric binder; and the AIL and CIL each independently have a thickness in the range of 25 µm to about 200 µm; each MWA is compressed between two gaskets to form a diluate chamber; a concentrate chamber is positioned between each diluate chamber; each diluate chamber is oriented with the AIL thereof facing the anode, and the CIL of thereof facing the cathode; and the concentrate chambers and diluate chambers configured and assembled for fluid flow therebetween.

20. The MWA-EDI apparatus of claim 19, wherein bipolar membranes are positioned between the cathode and the stack and between the anode and the stack.
